(19) United States
(12) Patent Application Publication
(10) Pub. No.: US 2024/0078901 A1
(43) Pub. Date: Mar. 7, 2024

(54) Vehicle and Method for Reflecting Safe Driving Index of Driver

(71) Applicants: Hyundai Motor Company, Seoul (KR); Kia Corporation, Seoul (KR)

(72) Inventors: Donghee Seok, Seoul (KR); Jong Bok Lee, Yongin-si (KR)

(21) Appl. No.: 18/187,039

(22) Filed: Mar. 21, 2023

(30) Foreign Application Priority Data
Sep. 6, 2022 (KR) 10-2022-0112866

(51) Int. Cl. G08G 1/04; B60Q 1/46; G06V 20/56; G06V 20/58; G08G 1/0967

(52) U.S. Cl. CPC G08G 1/04; B60Q 1/46; G06V 20/58; G06V 20/588; G08G 1/096791

(57) ABSTRACT

An embodiment vehicle includes a road condition analysis part configured to analyze a road condition shown in image data captured by a camera a set period of time ago, when a driving pattern of a driver is out of a normal range during driving, and a safe driving index reflection part configured to determine whether the driving pattern of the driver is appropriate for the road condition based on the analyzed road condition and to transmit result data of the determination outside the vehicle to reflect the result data in a safe driving index of the driver.

### CROSS-REFERENCE TO RELATED APPLICATIONS

This application claims the benefit of Korean Patent Application No. 10-2022-0112866, filed on Sep. 6, 2022, which application is hereby incorporated herein by reference.

### TECHNICAL FIELD

The disclosure relates to a vehicle and a method for reflecting a safe driving index of a driver of the vehicle.

### BACKGROUND

A driver's driving pattern may be used for automobile insurance and various applications. Also, a safe driving index may be adjusted upwards or downwards according to a driver's driving pattern.

A safe driving index is used as an indicator of a driver's safe driving by applying a driver's driving patterns such as sudden acceleration, sudden deceleration, sudden stop, sudden turn, etc. For example, when a vehicle takes a sudden acceleration, sudden deceleration, sudden stop, sudden turn, etc., due to a driver's bad driving habit, a safe driving index may be lowered.

However, when a sudden deceleration, sudden stop, etc., occurs in the event of finding an obstacle, accident, and roadkill, which is uncontrollable, a safe driving index is required to be adjusted by determining whether a driver's driving pattern was appropriate for road conditions.

### SUMMARY

An embodiment of the disclosure provides a vehicle and a method for reflecting a safe driving index of a driver of the vehicle that may, when a driver's driving pattern is out of a normal range, determine whether the driver's driving pattern was appropriate for a road condition through road condition analysis, and reflect the determination in a driver's safe driving index.

Additional embodiments of the disclosure will be set forth in part in the description which follows and, in part, will be obvious from the description, or may be learned by practice of embodiments of the disclosure.

An embodiment of the disclosure provides a vehicle including a road condition analysis part configured to analyze a road condition shown in image data captured by a camera a set period of time ago, when a driving pattern of a driver is out of a normal range during driving, and a safe driving index reflection part configured to determine whether the driver's driving pattern is appropriate for the road condition based on the analyzed road condition and to transmit result data of the determination to a management server, located in a remote place, to reflect the result data in a safe driving index of the driver.

The road condition analysis part includes a sensor configured to detect at least one of sudden acceleration, sudden deceleration, sudden stop, or sudden lane change during driving, and a driving pattern analysis part configured to determine that the driver's driving pattern is out of the normal range, when a value detected by the sensor exceeds a preset range.

The road condition analysis part further includes a camera recognition part configured to determine whether the camera is installed, when the driver's driving pattern is determined to be out of the normal range by the driving pattern analysis part, and when the camera is determined to be installed by the camera recognition part, the road condition analysis part is configured to receive the image data captured by the camera the set period of time ago and analyze the road condition shown in the image data.

The road condition analysis part further includes a location information transmission part configured to transmit, to the management server, location information of the vehicle at a point in time that the driver's driving pattern is out of the normal range, when the camera is not determined to be installed by the camera recognition part.

The road condition analysis part includes an obstacle information transmission part configured to transmit, to the management server, obstacle-related information including at least one of a size and a location of an obstacle, a lane, or a time, when the obstacle is recognized in the road condition shown in the image data.

The safe driving index reflection part includes a data generation part configured to generate the result data to be transmitted to the management server, and the data generation part is configured to generate the result data so that the management server increases the driver's safe driving index, when the driver's driving pattern is determined to be appropriate for the road condition.

The safe driving index reflection part further includes a follow-up action reflection part configured to transmit, to the data generation part, information about whether hazard lights flash, when the driver turns on the hazard lights to inform a following vehicle of the road condition, and the data generation part is configured to generate the result data including the information about whether the hazard lights flash so that the management server increases the driver's safe driving index, the information about whether the hazard lights flash being received from the follow-up action reflection part.

The vehicle further includes an auxiliary analysis part configured to analyze a road condition shown in image data captured by the camera a set period of time ago from a point in time that the vehicle reaches a location corresponding to location information of a preceding vehicle, when the location information of the preceding vehicle is received from the management server, and an auxiliary index reflection part configured to determine whether a driving pattern of a driver of the preceding vehicle is appropriate for the road condition based on the analyzed road condition, and transmit result data of the determination to the management server to reflect the result data in a safe driving index of the driver of the preceding vehicle.

Another embodiment of the disclosure provides a method for reflecting a safe driving index of a driver of a vehicle, the method including determining, by the vehicle, whether a camera is installed in the vehicle of the driver, when a driving pattern of the driver is out of a normal range while the vehicle is driving, analyzing, by the vehicle, a road condition shown in image data captured by the camera a set period of time ago, when the camera is installed in the vehicle, determining, by the vehicle, whether the driver's driving pattern is appropriate for the road condition based on the analyzed road condition, transmitting result data of the determination to a management server located in a remote place, and adjusting, by the management server, a safe driving index of the driver based on the result data.

When the camera is not installed, the determining of whether the camera is installed includes transmitting, by the vehicle, location information of the vehicle at a point in time that the driver's driving pattern is out of the normal range, to the management server, transmitting, by the management server, the location information of the vehicle to a following vehicle of the vehicle, receiving, by the management server, the result data about whether the driver's driving pattern is appropriate for the road condition from the following vehicle, and adjusting the safe driving index of the driver.

When an obstacle is recognized in the road condition shown in the image data, the analyzing of the road condition includes transmitting, by the vehicle, obstacle-related information including at least one of a size and a location of the obstacle, a lane, or a time, to the management server, determining, by the management server, whether the obstacle is a moving object based on the obstacle-related information, and when the obstacle is the moving object, transmitting, by the management server, the obstacle-related information to a following vehicle of the vehicle.

When the management server receives result data that the driver's driving pattern is appropriate for the road condition, the adjusting of the safe driving index of the driver includes increasing the safe driving index of the driver based on the result data.

The method further includes, when the driver turns on hazard lights to inform the following vehicle of the road condition, transmitting, by the vehicle, information about whether the hazard lights flash to the management server, receiving, by the management server, the information about whether the hazard lights flash, and increasing the safe driving index of the driver.

### BRIEF DESCRIPTION OF THE DRAWINGS

These and/or other embodiments of the disclosure will become apparent and more readily appreciated from the following description of the embodiments, taken in conjunction with the accompanying drawings, in which:

FIG. 1 is a block diagram illustrating a configuration of a vehicle according to an embodiment;

FIG. 2 is a flowchart illustrating a method for reflecting a safe driving index of a driver of a vehicle according to an embodiment;

FIG. 3 is a flowchart illustrating operations of determining whether a driver's driving pattern is appropriate for a road condition and transmitting to a management server by a following vehicle of a vehicle, when a camera is not installed in the vehicle, in the method for reflecting a driver's safe driving index of FIG. 2; and

FIGS. 4A, 4B, and 4C are diagrams illustrating examples of a method for reflecting a safe driving index of a driver of a vehicle according to an embodiment.

### DETAILED DESCRIPTION OF ILLUSTRATIVE EMBODIMENTS

Like reference numerals throughout the specification denote like elements. Also, this specification does not describe all the elements according to embodiments of the disclosure, and descriptions well-known in the art to which the disclosure pertains or overlapped portions are omitted.

It will be understood that when an element is referred to as being “connected” to another element, it can be directly or indirectly connected to the other element, wherein the indirect connection includes “connection” via a wireless communication network.

It will be understood that the term “include” when used in this specification specifies the presence of stated features, integers, steps, operations, elements, and/or components, but does not preclude the presence or addition of at least one other feature, integer, step, operation, element, component, and/or group thereof.

It is to be understood that the singular forms are intended to include the plural forms as well, unless the context clearly dictates otherwise.

The terms such as “˜part,” “˜device,” “˜block,” “˜member”, “˜module,” and the like may refer to a unit for processing at least one function or act. For example, the terms may refer to at least process processed by at least one hardware, such as a field-programmable gate array (FPGA)/application specific integrated circuit (ASIC), software stored in memories or processors.

Reference numerals used for method steps are just used for convenience of explanation, but not to limit an order of the steps. Thus, unless the context clearly dictates otherwise, the written order may be practiced otherwise.

Hereinafter, embodiments of the disclosure will be described in detail with reference to the accompanying drawings.

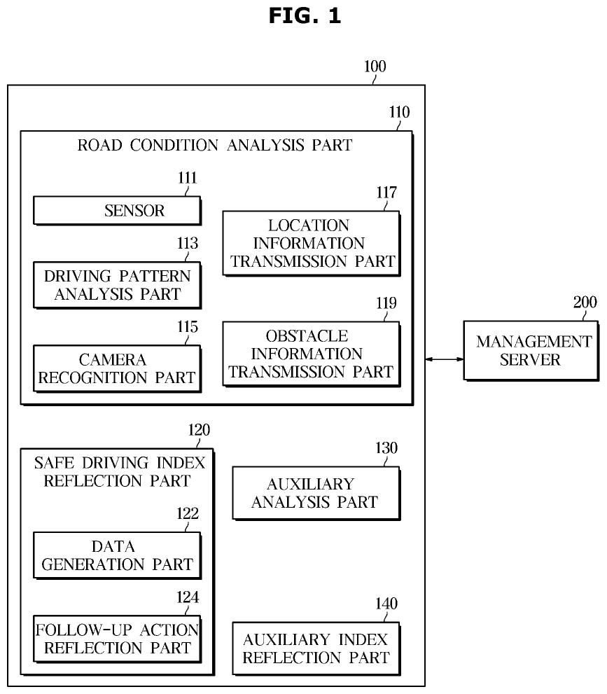

FIG. 1 is a block diagram illustrating a configuration of a vehicle according to an embodiment.

When a driving pattern of a driver is out of a normal range during driving, a vehicle 100 according to an embodiment may determine whether the driver's driving pattern is appropriate for a road condition by analyzing a front road condition and transmit a result of determination to a management server 200 located in a remote place so that the result is reflected in a safe driving index of the driver.

That is, even though the driver took a sudden acceleration, sudden deceleration, sudden stop, sudden lane change, or the like, when it is determined that the driver's driving was appropriate in an uncontrollable situation such as detecting an obstacle, an accident or a parked vehicle, roadkill, etc., in front of the vehicle, the vehicle 100 may transmit result data of the determination, so that a safe driving index of the driver is increased.

Through the above, a disadvantage of lowering a driver's safe driving index without considering a road condition when the driver suddenly stops, accelerates, decelerates, rotates, etc., may be overcome.

Referring to FIG. 1, the vehicle 100 according to an embodiment may include a road condition analysis part 11o and a safe driving index reflection part 120. In this instance, the road condition analysis part 11o analyzes a road condition shown in image data captured by a camera a set period of time ago, when a driving pattern of a driver is out of a normal range during driving. The safe driving index reflection part 120 determines whether the driver's driving pattern is appropriate for the road condition based on the road condition analyzed by the road condition analysis part 11o and transmits result data of the determination to a management server 200, located in a remote place, to reflect the result data in a safe driving index of the driver.

Here, the road condition analysis part 110 may include a sensor 111 detecting at least one of sudden acceleration, sudden deceleration, sudden stop, or sudden lane change during driving, and a driving pattern analysis part 113 determining that the driver's driving pattern is out of the normal range, when a value detected by the sensor 111 exceeds a preset range.

Also, the road condition analysis part 110 may include a camera recognition part 115 determining whether the camera is installed, when the driver's driving pattern is determined to be out of the normal range by the driving pattern analysis part 113.

The camera may obtain images of another vehicle located in front, at rear, and at sides of the vehicle 100, images around the vehicle 100, images of the road condition in front of the vehicle 100, and the like.

Here, when it is determined by the camera recognition part 115 that the camera is installed, the road condition analysis part 11o may receive the image data captured by the camera a set period of time ago and analyze a road condition shown in the image data.

Also, when it is not determined by the camera recognition part 115 that the camera is installed in the vehicle 100, the road condition analysis part 11o may include a location information transmission part 117 transmitting location information of the vehicle 100 at a point in time that the driver's driving pattern is out of the normal range to the management server 200.

In addition, the road condition analysis part 110 may include an obstacle information transmission part 119 transmitting obstacle-related information to the management server 200, when an obstacle is recognized in the road condition shown in the image data. In this instance, the obstacle-related information includes at least one of a size and a location of an obstacle, a lane, or a time.

The safe driving index reflection part 120 may include a data generation part 122 generating result data to be transmitted to the management server 200.

In this instance, when it is determined that the driver's driving pattern is appropriate for the road condition, the data generation part 122 may generate result data so that the management server 200 increases the driver's safe driving index.

Also, the safe driving index reflection part 120 may include a follow-up action reflection part 124 transmitting information about whether hazard lights flash to the data generation part 122, when the driver turns on the hazard lights to inform a following vehicle of the vehicle 100 of the road condition.

In this instance, the data generation part 122 may generate result data including the information about whether the hazard lights flash received from the follow-up action reflection part 124, so that the management server 200 increases the driver's safe driving index.

According to an embodiment, the vehicle 100 may further include an auxiliary analysis part 130 and an auxiliary index reflection part 140. Here, when location information of a preceding vehicle of the vehicle 100 is received from the management server 200, the auxiliary analysis part 130 may analyze a front road condition shown in image data captured by the camera a set period of time ago from a point in time that the vehicle 100 reaches a location corresponding to the location information of the preceding vehicle. The auxiliary index reflection part 140 may determine whether a driving pattern of a driver of the preceding vehicle is appropriate for the road condition based on the analyzed road condition and transmit result data of the determination to the management server 200 to reflect the result data in a safe driving index of the driver of the preceding vehicle.

Hereinafter, constituent components of the vehicle 100 according to an embodiment are described in detail.

The road condition analysis part 11o may analyze a road condition shown in image data captured by a camera a set period of time ago, when a driving pattern of a driver is out of a normal range during driving. The road condition analysis part 110 may include the sensor 111, the driving pattern analysis part 113, the camera recognition part 115, the location information transmission part 117, and the obstacle information transmission part 119.

The sensor 11 detects at least one of sudden acceleration, sudden deceleration, sudden stop, or sudden lane change during driving.

To this end, the sensor in may include a variety of sensors that detect, for example, a pressure of an accelerator and a brake, an angle of a steering wheel, a location of the vehicle, a driving speed, a lane change, and the like.

The driving pattern analysis part 113 may determine that the driver's driving pattern is out of the normal range, when a value detected by the sensor in exceeds a preset range.

The camera recognition part 115 may determine whether the camera is installed in the vehicle 100, when it is determined by the driving pattern analysis part 113 that the driver's driving pattern is out of the normal range.

The camera may include a built-in camera, and the like, and be provided with a memory storing captured image data. When it is determined by the camera recognition part 115 that the camera is installed, the road condition analysis part 11o receives the image data captured by the camera a set period of time ago and analyzes the road condition shown in the image data.

When it is not determined by the camera recognition part 115 that the camera is installed in the vehicle 100, the location information transmission part 117 may transmit location information of the vehicle 100 at a point in time that the driver's driving pattern is out of the normal range to the management server 200. For example, the location information of the vehicle 100 may be generated by a global positioning system (GPS) device, etc. In another example, the location information transmission part 117 may transmit, to the management server 200, location information of the vehicle 100 within a set period of time after the driver's driving pattern is out of the normal range.

When an obstacle is recognized in the road condition shown in the image data captured by the camera of the vehicle 100, the obstacle information transmission part 119 may transmit obstacle-related information including a size and a location of the obstacle, a lane, a time, etc., to the management server 200.

In another example, when an obstacle is detected by an ultrasonic sensor, a radar sensor, etc., provided in the vehicle 100, the obstacle information transmission part 119 may transmit obstacle-related information including a size and a location of the obstacle, a lane, etc., to the management server 200.

The safe driving index reflection part 120 determines whether the driver's driving pattern is appropriate for the road condition based on the road condition analyzed by the road condition analysis part 110 and transmits result data of the determination to the management server 200 located in a remote place so that the result data is reflected in the safe driving index of the driver. The safe driving index reflection part 120 includes the data generation part 122 and the follow-up action reflection part 124.

When it is determined by the road condition analysis part 11o that the driver's driving pattern is appropriate for the road condition, the data generation part 122 generates the result data to be transmitted to the management server 200 so that the driver's safe driving index is increased.

When the driver turns on hazard lights to inform a following vehicle of the vehicle 100 of the road condition, the follow-up action reflection part 124 transmits information about whether the hazard lights flash to the data generation part 122 to reflect the information in the above-described result data.

Through the above, the data generation part 122 generates the result data by reflecting the determination of the road condition analysis part 11o that the driver's driving pattern is appropriate for the road condition as well as the information about whether the hazard lights flash and transmits to the management server 200, thereby allowing the driver's safe driving index to increase.

In another example, the information about whether the hazard lights flash depending on the road condition may be transmitted to the management server 200 separately from the above-described result data and may be reflected in adjustment of the driver's safe driving index. For example, when the camera is not installed in the vehicle 100, the vehicle 100 transmits the information about whether the hazard lights flash to the management server 200. Also, when a following vehicle of the vehicle 100 determines whether the driver's driving pattern is appropriate for the road condition and transmits result data of the determination to the management server 200, the result data and the action of turning the hazard lights on may be reflected in the adjustment of the safe driving index of the driver of the vehicle 100.

The result data generated by the data generation part 122 may include a request message for adjusting the driver's safe driving index, information about the driver and the vehicle, the obstacle-related information, location information of the vehicle, various analysis information, detection information, and the like. The result data may be transmitted to the management server 200 through wireless communication.

Meanwhile, when a camera capable of capturing a front road condition is installed in the vehicle 100, a preceding vehicle of the vehicle 100 has no camera installed, and a driving pattern of a driver of the preceding vehicle is out of a normal range, the vehicle 100 may receive location information of the preceding vehicle from the management server 200. In this instance, the location information of the preceding vehicle may include location information at a point in time that the preceding vehicle driver's driving pattern is out of the normal range.

In this case, the vehicle 100 determines whether the preceding vehicle driver's driving pattern is appropriate for the road condition and transmits to the management server 200, thereby assisting in reflecting the preceding vehicle driver's driving pattern.

To this end, the auxiliary analysis part 130 analyzes the road condition shown in image data captured by the camera of the vehicle 100 a set period of time ago, based on a point in time that the vehicle 100 reaches a location corresponding to the location information of the preceding vehicle received from the management server 200. Such operation of the auxiliary analysis part 130 may be performed identically to the above-described operation of the road condition analysis part 110.

The auxiliary index reflection part 140 may determine whether the preceding vehicle driver's driving pattern is appropriate for the road condition based on the road condition analyzed by the auxiliary analysis part 130, and transmit result data of the determination to the management server 200 to reflect the result data in a preceding vehicle driver's safe driving index. An operation of the auxiliary index reflection part 140 may be performed identically to the above-described operation of the safe driving index reflection part 120.

Although not illustrated, the vehicle 100 may include a controller for controlling the above-described constituent components of the vehicle 100 and other related components. The controller may include various processors and memories. The memory may store programs, instructions, applications, etc., for performing vehicle control. Each of the processors may execute the programs, the instructions, the applications, etc., stored in the memory. For example, the controller may include control units such as an electronic control unit (ECU), a micro controller unit (MCU), and the like.

For example, the memory may include a volatile memory such as a random access memory (RAM), a non-volatile memory such as a flash memory, a read only memory (ROM), a programmable read only memory (PROM), an erasable programmable read only memory (EPROM), an electrically erasable programmable read only memory (EEPROM), and a recording medium such as a hard disk drive (HDD), or a compact disc read only memory (CD-ROM). Information such as information detected by the sensor 111, information related to a driving pattern, image data captured by a camera and various sensors, analysis data, various information related to a vehicle and a driver, and information related to time and location may be stored in the memory.

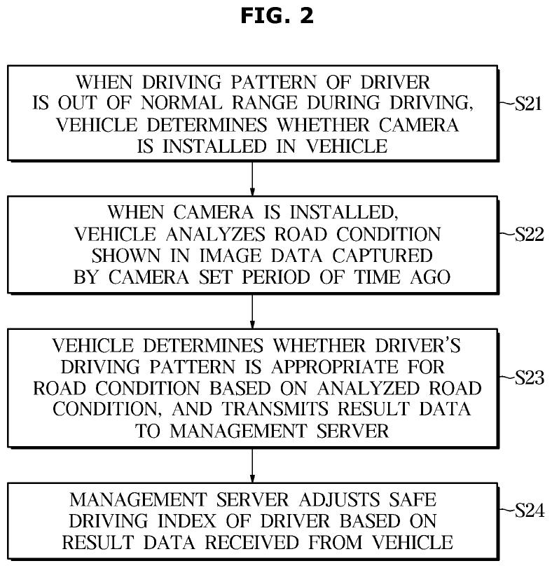

FIG. 2 is a flowchart illustrating a method for reflecting a safe driving index of a driver of a vehicle according to an embodiment.

Referring to FIG. 2, when a driving pattern of a driver is out of a normal range during driving, the vehicle 100 determines whether a camera is installed in a vehicle of the driver (S21).

Next, when the camera is installed, the vehicle 100 analyzes a road condition shown in image data captured by the camera a set period of time ago (S22).

In this instance (operation S22), when an obstacle is recognized in the road condition shown in the image data, the vehicle 100 transmits obstacle-related information including a size and a location of an obstacle, a lane, a time, etc., to the management server 200. The management server 200 may determine whether the obstacle is a moving object based on the obstacle-related information, and when the obstacle is a moving object, may inform a following vehicle of the vehicle 100 of the obstacle-related information.

Here, the management server 200 may collect the obstacle-related information continuously reported based on timestamp and may determine whether the obstacle is a moving object by analyzing a location of the obstacle, lanes, etc. The obstacle-related information may be included in result data to be described later and transmitted to the management server 200.

Afterwards, the vehicle 100 determines whether the driver's driving pattern is appropriate for the road condition based on the analyzed road condition and transmits the result data to the management server 200 located in a remote place (S23).

Next, the management server 200 adjusts a safe driving index of the driver based on the result data received from the vehicle 100 (S24).

In this instance (operation S24), when receiving result data of a determination that the driver's driving pattern is appropriate for the road condition from the vehicle 100, the management server 200 may increase the driver's safe driving index based on the result data.

Also, when the driver turns on hazard lights to inform a following vehicle of the vehicle 100 of the road condition and the vehicle 100 transmits information about whether the hazard lights flash to the management server 200, the management server 200 may receive the information about whether the hazard lights flash and additionally perform an operation of increasing the driver's safe driving index.

The information about whether the hazard lights flash by the driver of the vehicle 100 may be included in the above-described result data and transmitted to the management server 200.

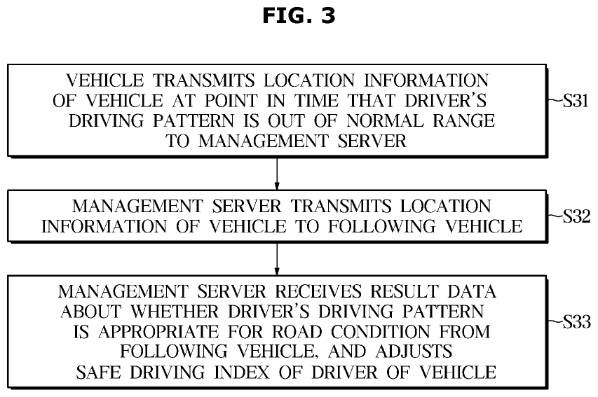

FIG. 3 is a flowchart illustrating operations of determining whether a driver's driving pattern is appropriate for a road condition and transmitting to a management server by a following vehicle of a vehicle, when a camera is not installed in the vehicle, in the method for reflecting a driver's safe driving index of FIG. 2.

Meanwhile, in operation S21 described above, when the camera is not installed in the vehicle 100, the vehicle 100 transmits location information of the vehicle 100 at a point in time that the driver's driving pattern is out of the normal range to the management server 200 (S31), as shown in FIG. 3.

Next, the management server 200 transmits the location information of the vehicle 100 to a following vehicle of the vehicle 100 (S32).

Afterwards, the management server 200 receives result data about whether the driving pattern of the driver of the vehicle 100 is appropriate for the road condition from the following vehicle, and adjusts the safe driving index of the driver of the vehicle 100 (S33).

Here, as described with respect to the auxiliary analysis part 130 and the auxiliary index reflection part 140, the following vehicle may determine whether the driving pattern of the driver of the vehicle 100 is appropriate for the road condition and transmit a result of the determination to the management server 200.

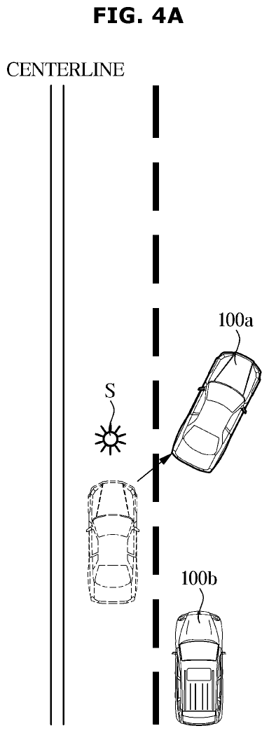

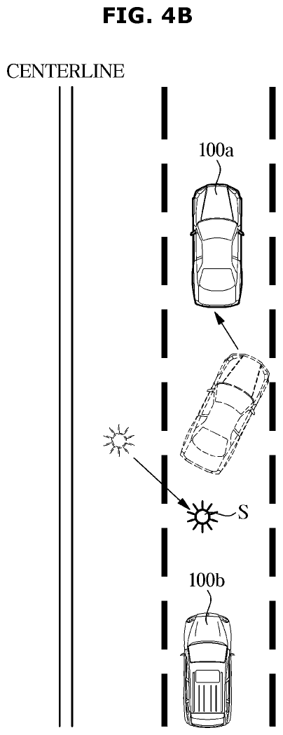

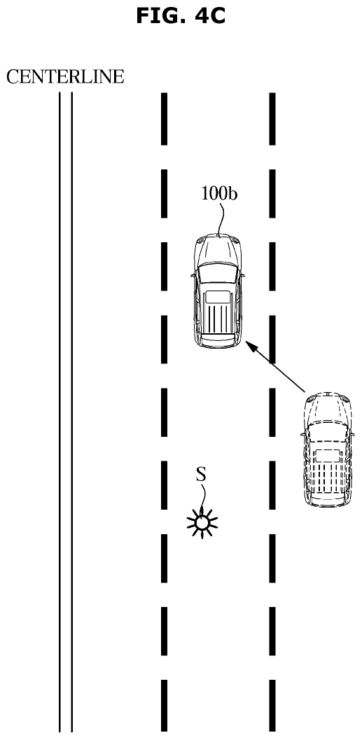

FIGS. 4A, 4B, and 4C are diagrams illustrating examples of a method for reflecting a safe driving index of a driver of a vehicle according to an embodiment.

As shown in FIG. 4A, when a driver of a first vehicle 100a detects an obstacle S in a first lane and suddenly changes to a second lane, the first vehicle 100a analyzes a front road condition shown in image data captured by a camera a set period of time ago, at a point in time that the driver of the first vehicle 100a changes to the second lane, i.e., based on the point in time that a driving pattern of the driver is out of a normal range, and determines whether the driver's driving pattern is appropriate for the road condition. Also, the first vehicle 100a transmits result data of the determination to the management server 200 located in a remote place so that the result data is reflected in a safe driving index of the driver. In this instance, when it is determined that the driver's driving pattern is appropriate for the road condition, the driver's safe driving index may be increased.

Also, when the driver of the first vehicle 100a informs a following vehicle (a second vehicle 100b) of the vehicle 100 of the road condition by flashing hazard lights, the management server 200 may additionally increase the safe driving index of the driver of the first vehicle 100a for the flash of the hazard lights.

In addition, the first vehicle 100a may transmit obstacle-related information including a size of the obstacle S, the lane where the obstacle S is detected (the first lane), a time that the obstacle S is detected, etc., to the management server 200. The management server 200 may store and analyze the obstacle-related information and inform the second vehicle 100b of the obstacle-related information.

When a camera capturing the road condition is not installed in the first vehicle 100a, the first vehicle 100a transmits location information of the first vehicle 100a at a point in time that the driver of the first vehicle 100a suddenly changes to another lane, i.e., the point in time that the driver's driving pattern is out of the normal range, to the management server 200. The management server 200 transmits the location information of the first vehicle 100a to the second vehicle 100b.

When the second vehicle 100b reaches a location corresponding to the location information of the first vehicle 100a, the second vehicle 100b analyzes the road condition shown in the image data captured by the camera of the second vehicle 100b a set period of time ago and determines whether the driving pattern of the driver of the first vehicle 100a is appropriate for the road condition. Also, the second vehicle 100b transmits result data to the management server 200, thereby assisting in reflecting the result data in the safe driving index of the driver of the first vehicle 100a.

As shown in FIGS. 4B and 4C, the second vehicle 100b may receive the obstacle-related information from the management server 200, thereby effectively avoiding the obstacle S.

Also, through analysis of the image data about the road condition, the second vehicle 100b may transmit obstacle-related information including a size of the obstacle S, the lane where the obstacle S is detected (the second lane), a time that the obstacle S is detected, etc., to the management server 200. The management server 200 may store and analyze the obstacle-related information and inform another vehicle of the obstacle-related information.

The management server 200 may continuously collect and analyze the information related to the obstacle S from other vehicles, determine whether the obstacle is a moving object, and inform other vehicles, and thus an accident may be prevented.

As is apparent from the above, according to the embodiments of the disclosure, when a driver's driving pattern is out of a normal range, the vehicle and the method for reflecting a safe driving index of the driver of the vehicle can determine whether the driver's driving pattern is appropriate for a road condition through analysis of the road condition and reflect a result of the determination in the driver's safe driving index.

Although embodiments have been described for illustrative purposes, those skilled in the art will appreciate that various modifications, additions, and substitutions are possible, without departing from the scope and spirit of the disclosure. Therefore, embodiments have not been described for limiting purposes.

What is claimed is:

1. A vehicle comprising:
a road condition analysis part configured to analyze a road condition shown in image data captured by a camera a set period of time ago, when a driving pattern of a driver is out of a normal range during driving; and
a safe driving index reflection part configured to determine whether the driving pattern of the driver is appropriate for the road condition based on the analyzed road condition and to transmit result data of the determination to a management server remote from the vehicle to reflect the result data in a safe driving index of the driver.

2. The vehicle of claim 1, wherein the road condition analysis part comprises a sensor configured to detect a sudden acceleration, a sudden deceleration, a sudden stop, or a sudden lane change during driving.

3. The vehicle of claim 2, wherein the road condition analysis part further comprises a driving pattern analysis part configured to determine that the driving pattern of the driver is out of the normal range when a value detected by the sensor exceeds a preset range.

4. The vehicle of claim 3, wherein the road condition analysis part further comprises a camera recognition part configured to determine whether the camera is installed, when the driving pattern of the driver is determined to be out of the normal range by the driving pattern analysis part.

5. The vehicle of claim 4, wherein, in response to a determination by the camera recognition part that the camera is installed, the road condition analysis part is configured to receive the image data captured by the camera the set period of time ago and analyze the road condition shown in the image data.

6. The vehicle of claim 4, wherein the road condition analysis part further comprises a location information transmission part configured to transmit location information of the vehicle at a point in time that the driving pattern of the driver is out of the normal range, in response to a determination by the camera recognition part that the camera is not installed.

7. The vehicle of claim 1, wherein the road condition analysis part comprises an obstacle information transmission part configured to transmit obstacle-related information including a size and a location of an obstacle, a lane, or a time, when the obstacle is recognized in the road condition shown in the image data.

8. The vehicle of claim 1, wherein the safe driving index reflection part comprises a data generation part configured to generate the result data to increase the safe driving index of the driver, in response to a determination that the driving pattern of the driver is appropriate for the road condition.

9. The vehicle of claim 8, wherein the safe driving index reflection part further comprises:
a follow-up action reflection part configured to transmit, to the data generation part, information about whether hazard lights flash, when the driver turns on the hazard lights to inform a following vehicle of the road condition; and
the data generation part is configured to generate the result data including the information about whether the hazard lights flash to increase the safe driving index of the driver, the information about whether the hazard lights flash being received from the follow-up action reflection part.

10. The vehicle of claim 1, further comprising:
an auxiliary analysis part configured to analyze the road condition shown in the image data captured by the camera the set period of time ago from a point in time that the vehicle reaches a location corresponding to location information of a preceding vehicle, when the location information of the preceding vehicle is received; and
an auxiliary index reflection part configured to determine whether a driving pattern of a driver of the preceding vehicle is appropriate for the road condition based on the analyzed road condition and to transmit result data of the determination to reflect the result data in a safe driving index of the driver of the preceding vehicle.

11. A method for reflecting a safe driving index of a driver of a vehicle, the method comprising:
determining whether a camera is installed in the vehicle of the driver, when a driving pattern of the driver is out of a normal range while the vehicle is driving;
analyzing a road condition shown in image data captured by the camera a set period of time ago, in response to a determination that the camera is installed in the vehicle;
determining, by the vehicle, whether the driving pattern of the driver is appropriate for the road condition based on the analyzed road condition;
transmitting result data of the determination of whether the driving pattern of the driver is appropriate from the vehicle to a management server remote from the vehicle so that the management server can adjust a safe driving index of the driver based on the result data.

12. The method of claim 11, wherein, in response to a determination that the camera is not installed in the vehicle, the method further comprises:
transmitting location information of the vehicle at a point in time that the driving pattern of the driver is out of the normal range, the location information of the vehicle being transmitted to a following vehicle of the vehicle;
receiving result data indicating whether the driving pattern of the driver is appropriate for the road condition from the following vehicle so that the management server can adjust the safe driving index of the driver based on the result data received from the following vehicle.

13. The method of claim 11, wherein, when an obstacle is recognized in the road condition shown in the image data, analyzing the road condition comprises:
transmitting obstacle-related information including a size and a location of the obstacle, a lane, or a time;
determining whether the obstacle is a moving object based on the obstacle-related information; and
in response to a determination that the obstacle is the moving object, transmitting the obstacle-related information to a following vehicle of the vehicle.

14. The method of claim 11, further comprising adjusting, by the management server, the safe driving index of the driver based on the result data.

15. The method of claim 14, wherein adjusting the safe driving index of the driver comprises increasing the safe driving index of the driver in response to the result data indicating that the driving pattern of the driver is appropriate for the road condition.

16. The method of claim 15, further comprising:
when the driver turns on hazard lights to inform a following vehicle of the road condition, receiving information indicating the hazard lights flashed; and
increasing the safe driving index of the driver.

17. A method for reflecting a safe driving index of a driver of a vehicle, the method comprising:
receiving result data relating to whether a driving pattern of the driver is appropriate when a driving pattern of the driver is out of a normal range while the vehicle is driving; and
adjusting a safe driving index of the driver based on the received result data;
wherein, when a camera that can capture image data related to a road condition is installed in the vehicle, the result data is received from the vehicle and is based on the driving pattern of the driver and the road condition shown in image data captured by the camera; and
wherein, when the camera is not installed in the vehicle, the method further comprises transmitting location information of the vehicle to a following vehicle of the vehicle, the result data being received from the following vehicle.

18. The method of claim 17, wherein an obstacle is recognized in the road condition, the method further comprising:
receiving obstacle-related information including a size and a location of the obstacle, a lane, or a time;
determining that the obstacle is a moving object based on the obstacle-related information; and
in response to determining that the obstacle is the moving object, transmitting the obstacle-related information to the following vehicle of the vehicle.

19. The method of claim 17, wherein adjusting the safe driving index of the driver comprises increasing the safe driving index of the driver in response to the result data indicating that the driving pattern of the driver is appropriate for the road condition.

20. The method of claim 19, further comprising:
receiving hazard-light related information indicating hazard lights of the vehicle are being flashed to inform the following vehicle of the road condition; and
increasing the safe driving index of the driver in response to the received hazard-light related information.
